(19) United States
(12) Patent Application Publication
(10) Pub. No.: US 2014/0198183 A1
(43) Pub. Date: Jul. 17, 2014

(54) SENSING PIXEL AND IMAGE SENSOR INCLUDING SAME

(71) Applicant: SAMSUNG ELECTRONICS CO., LTD., Suwon-si (KR)

(72) Inventors: Seoung-hyun Kim, Hwaseong-si (KR); Yong-jei Lee, Seongnam-si (KR); Joo-yeong Gong, Suwon-si (KR); Sung-chul Kim, Hwaseong-si (KR); Yoon-dong Park, Osan-si (KR); Hee-woo Park, Seoul (KR); Seung-won Cha, Daejeon (KR)

(73) Assignee: SAMSUNG ELECTRONICS CO., LTD., Suwon-si (KR)

(21) Appl. No.: 14/155,815

(22) Filed: Jan. 15, 2014

(30) Foreign Application Priority Data
Jan. 16, 2013 (KR) 10-2013-0005113

(51) Int. Cl. H04N 13/02

(52) U.S. Cl. CPC H04N 13/0257
USPC 348/46; 250/214 R

(57) ABSTRACT

A depth-sensing pixel included in a three-dimensional (3D) image sensor includes: a photoelectric conversion device configured to generate an electrical charge by converting modulated light reflected by a subject; a capture transistor, controlled by a capture signal applied to the gate thereof, the photoelectric conversion device being connected to the drain thereof; and a transfer transistor, controlled by a transfer signal applied to the gate thereof, the source of the capture transistor being connected to the drain thereof, and a floating diffusion region being connected to the source thereof.

### CROSS-REFERENCE TO RELATED APPLICATIONS

This application claims priority under 35 U.S.C. 119 to Korean Patent Application No. 10-2013-0005113 filed on Jan. 16, 2013, the disclosure of which is incorporated by reference herein in its entirety.

### TECHNICAL FIELD

The inventive concept relates to a depth-sensing pixel, and more particularly, to a three-dimensional (3D) sensing pixel and an image sensor including the same.

### DISCUSSION OF THE RELATED ART

With the wide spread use of digital cameras, digital camcorders, and cellular phones including functions thereof, depth-sensors and image sensors are rapidly being developed. An image captured by a conventional digital camera does not include information regarding the distance from the camera to a subject. To obtain accurate distance information to a subject, a time-of-flight (ToF) method of depth-measurement has been developed. The ToF method is a method of measuring a ToF of light reflected by a subject until the light is received by a light-receiving unit. According to the conventional ToF method, light of a specific wavelength (e.g., near infrared rays of 850 nm) is modulated and projected onto a subject by using a light-emitting diode (LED) or a laser diode (LD), and the light which is reflected by the subject is received within a time period by a light-receiving unit in proportion to the distance (time of flight).

### SUMMARY

An aspect of the inventive concept provides a depth-sensing pixel (i.e., a Depth-Sensing ELement (dsel) in an array of pixels) and an image sensing system to ensure a clear resolution of a three-dimensional (3D) surface. An aspect of the inventive concept provides method of removing most kTC noise in a ToF sensor.

According to an aspect of the inventive concept, there is provided a depth-sensing pixel included in a three-dimensional (3D) image sensor, the depth-sensing pixel including: a photoelectric conversion device for generating an electrical charge by converting modulated light reflected by a subject; a capture transistor, controlled by a capture signal applied to the gate thereof, and the photoelectric conversion device being connected to the drain thereof; and a transfer transistor, controlled by a transfer signal applied to the gate thereof, the source of the capture transistor being connected to the drain thereof, and a floating diffusion region being connected to the source thereof.

The capture signal is maintained High while the capture transistor is accumulating the electrical charge.

The transfer signal is maintained Low while the capture transistor is accumulating the electrical charge.

After the capture transistor accumulates the electrical charge for a predetermined period of time, the capture signal is changed to Low, and the transfer signal may be changed to High to thereby transfer the accumulated electrical charge to the floating diffusion region.

After the accumulated electrical charge is transferred to the floating diffusion region, signal-level sampling may be performed in the floating diffusion region.

The depth-sensing pixel may further include a reset transistor, controlled by a reset signal applied to the gate thereof, a power source voltage applied to the drain thereof, and the floating diffusion region being connected to the source thereof, wherein reset-level sampling is performed at the floating diffusion region by controlling the reset signal before the capture signal is changed to Low and the transfer signal is changed to high.

Impurity densities of the source and drain regions of the capture transistor may be lower than an impurity density of the floating diffusion region.

The capture signal may have a phase difference of at least one of 0°, 90°, 180°, and 270° with respect to the modulated light.

The capture transistor may be plural in number, capture signals having phase differences of 0° and 180° with respect to the modulated light may be applied to a first capture transistor of the plurality of capture transistors, and capture signals having phase differences of 90° and 270° with respect to the modulated light may be applied to a second capture transistor of the plurality of capture transistors.

The capture transistor may be plural in number, a capture signal having a phase difference of 0° with respect to the modulated light may be applied to a first capture transistor of the plurality of capture transistors, a capture signal having a phase difference of 90° with respect to the modulated light may be applied to a second capture transistor of the plurality of capture transistors, a capture signal having a phase difference of 180° with respect to the modulated light may be applied to a third capture transistor of the plurality of capture transistors, and a capture signal having a phase difference of 270° with respect to the modulated light may be applied to a fourth capture transistor of the plurality of capture transistors.

The depth-sensing pixel may convert an optical signal passing through a color filter for accepting any one of red, green, and blue to an electrical charge.

According to another aspect of the inventive concept, there is provided a three-dimensional (3D) image sensor including: a light source for emitting modulated light to a subject; a pixel array including at least one depth-sensing pixel for outputting an color-filtered pixel signal according to modulated light reflected by the subject; a row decoder for generating a driving signal for driving each row of the pixel array; an image processing unit for generating a color image and a depth image from pixel signals output from the pixel array; and a timing generation circuit for providing a timing signal and a control signal to the row decoder and the image processing unit, wherein the depth-sensing pixel includes: a photoelectric conversion device for generating an electrical charge by converting the modulated light reflected by the subject; a capture transistor, controlled by a capture signal applied to the gate thereof, and the photoelectric conversion device being connected to the drain thereof; and a transfer transistor, controlled by a transfer signal applied to the gate thereof, the source of the capture transistor being connected to the drain thereof, and a floating diffusion region being connected to the source thereof.

The capture signal is maintained High while the capture transistor is accumulating the electrical charge.

The transfer signal is maintained Low while the capture transistor is accumulating the electrical charge.

After the capture transistor accumulates the electrical charge for a predetermined period of time, the capture signal is changed to Low, and the transfer signal is changed to High to thereby transfer the accumulated electrical charge to the floating diffusion region.

Exemplary embodiments of the inventive concept will now be described in detail with reference to the accompanying drawings. The embodiments are provided to describe the inventive concept more fully to those of ordinary skill in the art. The inventive concept may allow various kinds of change or modification and various changes in form, and specific embodiments will be illustrated in drawings and described in detail in the specification. However, it should be understood that the specific embodiments do not limit the inventive concept to a specific disclosed form but include every modified, equivalent, or replaced one within the spirit and technical scope of the inventive concept. Like reference numerals in the drawings denote like elements. In the accompanying drawings, dimensions of structures are magnified or contracted compared to their actual dimensions for clarity of description.

The terminology used in the application is used only to describe specific embodiments and does not have any intention to limit the inventive concept. An expression in the singular includes an expression in the plural unless they are clearly different from each other in context.

All terms used herein including technical or scientific terms have the same meaning as those generally understood by one of ordinary skill in the art unless they are defined differently. It should be understood that terms generally used, which are defined in a dictionary, have the same meaning as in the context of related technology, and the terms are not understood as having an ideal or excessively formal meaning unless they are clearly defined in the application.

As used herein, expressions such as “at least one of,” when preceding a list of elements, modify the entire list of elements and do not modify the individual elements of the list.

### BRIEF DESCRIPTION OF THE DRAWINGS

Exemplary embodiments of the inventive concept will be more clearly understood from the following detailed description taken in conjunction with the accompanying drawings in which:

FIG. 1 is an equivalent circuit diagram one depth-sensing pixel (a plurality of which may be included in a three-dimensional (3D) image sensor), according to an exemplary embodiment of the inventive concept;

FIG. 2 is a cross-sectional view of the depth-sensing pixel of FIG. 1 integrated in a semiconductor device, according to an exemplary embodiment of the inventive concept;

FIG. 3 is a block diagram of a 3D image sensor, including an array of depth-sensing pixels of FIG. 1, according to an exemplary embodiment of the inventive concept;

FIG. 4A is an equivalent circuit diagram of an exemplary implementation of one depth-sensing pixel (a plurality of which may be included in a 3D image sensor), according to an exemplary embodiment of the inventive concept;

FIG. 4B is an equivalent circuit diagram of an exemplary implementation of one depth-sensing pixel included in a 3D image sensor, according to another embodiment of the inventive concept;

FIG. 5 is a timing diagram for describing an operation by the depth-sensing pixel of FIG. 1, 4A, or 4B;

FIG. 6A is a graph for describing an operation of calculating distance information or depth information by first and second photoelectric conversion devices of FIG. 1, according to an embodiment of the inventive concept;

FIG. 6B is a timing diagram for describing an operation of calculating distance information or depth information by the first and second photoelectric conversion devices of FIG. 1, according to another embodiment of the inventive concept;

FIG. 7 is a plan diagram for describing a Bayer color filter array disposed over the pixel array 12 in the 3D image sensor of FIG. 3;

FIG. 8 is a cross-sectional view along a line I-I′ of a portion of the pixel array of FIG. 7;

FIG. 9 is a timing diagram of first to fourth pixel signals in a red pixel of FIG. 7, according to an embodiment of the inventive concept;

FIG. 10 is a timing diagram of first to fourth pixel signals in a green pixel of FIG. 7, according to an embodiment of the inventive concept;

FIG. 11 is a timing diagram of first to fourth pixel signals in a blue pixel of FIG. 7, according to an embodiment of the inventive concept;

FIG. 12 is a block diagram of an image processing system using the image sensor of FIG. 3; and

FIG. 13 is a block diagram of a computer system including the image processing system of FIG. 12.

### DETAILED DESCRIPTION OF THE EMBODIMENTS

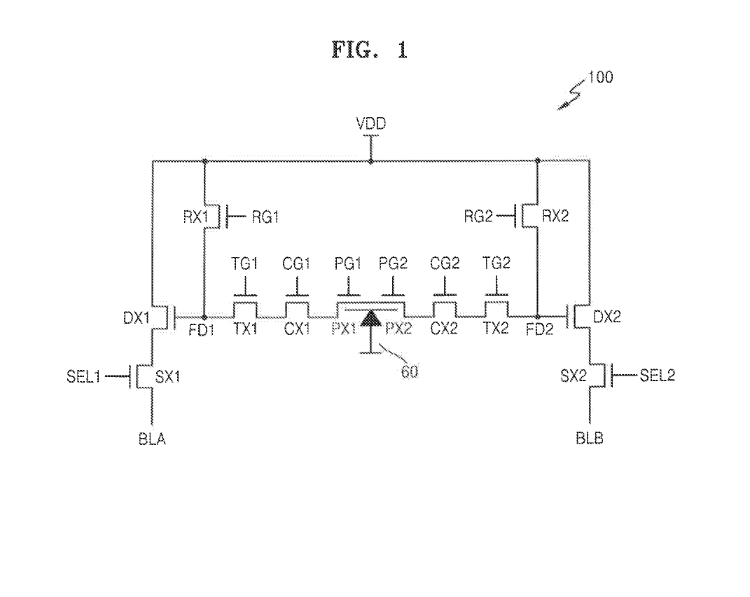

FIG. 1 is an equivalent circuit diagram corresponding to one depth-sensing pixel 100 included in a three-dimensional (3D) image sensor, according to an embodiment of the inventive concept.

An image sensor is formed by an array of small photodiode-based light detectors referred to as PICTure ELements (pixels) or photosites. In general, a pixel cannot directly extract colors from light reflected by an object or scene, but converts photons of a wide spectral band to electrons. A pixel in the image sensor must receive only light of a band required to acquire a color from among light of the wide spectral band. A pixel in the image sensor being combined with a color filter or the like thus filtered converts only photons corresponding to a specific color to electrons. Accordingly, the image sensor acquires a color image.

To acquire a depth image by using the image sensor's array of pixels, information regarding depth (i.e., the distance between a target object and the image sensor) needs to be obtained. A phase difference \hat{θ} occurs between modulated light that is emitted by a light source and the reflected light that is reflected by the target object and is incident to a pixel of the image sensor. The phase difference \hat{θ} indicates the time taken until the emitted modulated light is reflected by the target object and the reflected light is detected by the image sensor. The phase difference \hat{θ} may be used to calculate distance information or depth information between the target object and the image sensor. Thus, the image sensor array captures a depth image with an image reconfigured with respect to the distance between the target object and the image sensor by using time-of-flight (ToF).

Referring to FIG. 1, the depth-sensing pixel 100 has a two-tap pixel structure in which first and second photoelectric conversion devices PX1 and PX2 are formed in a photoelectric conversion region 60. The depth-sensing pixel 100 includes a first capture transistor CX1 connected to the first photoelectric conversion device PX1, a first transfer transistor TX1, a first drive transistor DX1, a first selection transistor SX1, and a first reset transistor RX1. In addition, the depth-sensing pixel 100 may further include a second capture transistor CX2 connected to the second photoelectric conversion device PX2, a second transfer transistor TX2, a second drive transistor DX2, a second selection transistor SX2, and a second reset transistor RX2.

The photoelectric conversion region 60 detects light. The photoelectric conversion region 60 generates electron-hole pairs (EHP) by converting the detected light. A depletion region may be formed in the first photoelectric conversion device PX1 by a voltage applied as a first gate signal PG1 at the first photoelectric conversion device PX1. The electrons and the holes in the EHPs are separated by the depletion region, and the electrons accumulate in a lower portion of the first photoelectric conversion device PX1.

A first capture signal CG1 is applied to the gate of the first capture transistor CX1, and the first photoelectric conversion device PX1 is connected to the drain thereof, and the first transfer transistor TX1 is connected to the source thereof. The first capture transistor CX1 hold electrons accumulated in the lower portion of the first photoelectric conversion device PX1 (opposite the gate thereof) until the electrons are transferred to the first transfer transistor TX1 in response to the first capture signal CG1. In response to the first capture signal CG1, the first capture transistor CX1 alternately electrically connects the first photoelectric conversion device PX1 to the first transfer transistor TX1 and electrically cuts off the first photoelectric conversion device PX1 and the first transfer transistor TX1 from each other.

In the first transfer transistor TX1, a first transfer signal TG1 is applied to the gate thereof, the first capture transistor CX1 is connected to the drain thereof, and a first floating diffusion region FD1 is connected to the source thereof. The first transfer transistor TX1 transfers the electrons received through the first capture transistor CX in response to the first transfer signal TG1. In response to the first capture signal CG1, the first transfer transistor TX1 alternately electrically connects the first capture transistor CX1 to the first floating diffusion region FD1 and electrically cuts off the first capture transistor CX1 and the first floating diffusion region FD1 from each other.

The first floating diffusion region FD1 is connected to the gate of the first drive transistor DX1, a power source voltage VDD is connected to the drain thereof, and the first selection transistor SX1 is connected to the source thereof. The voltage of the source terminal of the first drive transistor DX1 is determined by the voltage of the first floating diffusion region FD1. The voltage of the first floating diffusion region FD1 is determined by the amount of the accumulated electrons transferred from the first photoelectric conversion device PX1.

A first selection signal SEL1 (a row control signal) is applied to the gate of the first selection transistor SX1, the source of the first drive transistor DX1 is connected to the drain thereof, and a first bit line BLA in a pixel array is connected to the source thereof. A first pixel signal is output through the first bit line BLA.

A first reset signal RG1 is applied to the gate of the first reset transistor RX1, the power source voltage VDD is connected to the drain thereof, and the first floating diffusion region FD1 is connected to the source thereof. When the first reset signal RG1 is enabled after a pixel information detecting process is performed based on the voltage of the first floating diffusion region FD1, the first reset transistor RX1 resets the voltage of the first floating diffusion region FD1 to the power source voltage VDD.

The second photoelectric conversion device PX2 operates in the same manner as the first the first photoelectric conversion device PX1. A depletion region can be formed in the second photoelectric conversion device PX2 by a voltage applied as a second gate signal PG2. The electrons and holes in EHPs are separated by the depletion region, and the electrons are accumulated in a lower portion of the second photoelectric conversion device PX2 (opposite its gate).

A second capture signal CG2 is applied to the gate of the second capture transistor CX2, the second photoelectric conversion device PX2 is connected to the drain thereof, and the second transfer transistor TX2 is connected to the source thereof. In response to the second capture signal CG2, the second capture transistor CX2 alternately holds electrons in a lower portion of the second photoelectric conversion device PX2 (opposite its gate) and transfers the electrons to the second transfer transistor TX2. In response to the second capture signal CG2, the second capture transistor CX2 alternately electrically connects the second photoelectric conversion device PX2 to the second transfer transistor TX2 and electrically cuts off the second photoelectric conversion device PX2 and the second transfer transistor TX2 from each other.

In the second transfer transistor TX2, a second transfer signal TG2 is applied to the gate thereof, the second capture transistor CX2 is connected to the drain thereof, and a second floating diffusion region FD2 is connected to the source thereof. In response to the second transfer signal TG2, the second transfer transistor TX2 transfers the accumulated electrons received through the second capture transistor CX2. The second transfer transistor TX2 can electrically connect the second capture transistor CX2 to the second floating diffusion region FD2 or electrically cut off the second capture transistor CX2 and the second floating diffusion region FD2 from each other.

In the second drive transistor DX2, the second floating diffusion region FD2 is connected to the gate thereof, the power source voltage VDD is connected to the drain thereof, and the second selection transistor SX2 is connected to the source thereof. The voltage of a source terminal of the second drive transistor DX2 is determined by the voltage of the second floating diffusion region FD2. The voltage of the second floating diffusion region FD2 is determined by the amount of the accumulated electrons transferred from the second photoelectric conversion device PX2.

In the second selection transistor SX2, a second selection signal SEL2 (a row control signal) is applied to the gate thereof, the source of the second drive transistor DX2 is connected to the drain thereof, and a second bit line BLB in the pixel array is connected to the source thereof. A second pixel signal is output through the second bit line BLB.

In the second reset transistor RX2, a second reset signal RG2 is applied to the gate thereof, the power source voltage VDD is connected to the drain thereof, and the second floating diffusion region FD2 is connected to the source thereof. When the second reset signal RG2 is enabled after a pixel information detecting process is performed based on the voltage of the second floating diffusion region FD2, the second reset transistor RX2 resets the voltage of the second floating diffusion region FD2 to the power source voltage VDD.

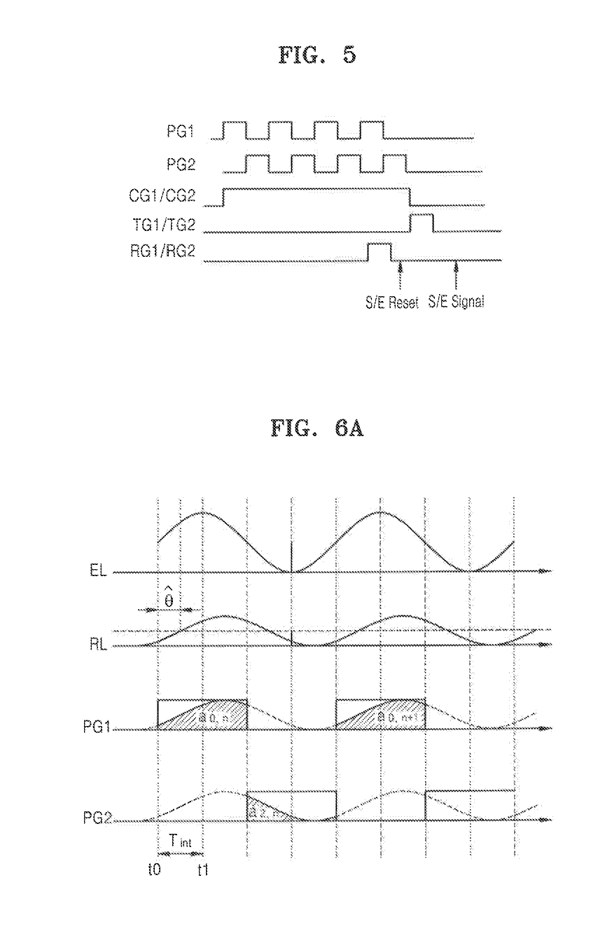

A more detailed description of the method of operation of the depth-sensing pixel 100 will be described below with respect to the timing diagram of FIG. 5.

Accordingly, since the operation of accumulating the electrons generated by the first and second photoelectric conversion devices PX1 and PX2 is distinguished from the operation of transferring the accumulated electrons to the first and second floating diffusion regions FD1 and FD2 via the first and second transfer transistors TX1 and TX2 in the depth-sensing pixel 100, the depth-sensing pixel 100 may provide a clear signal of high stability free of most kTC noise.

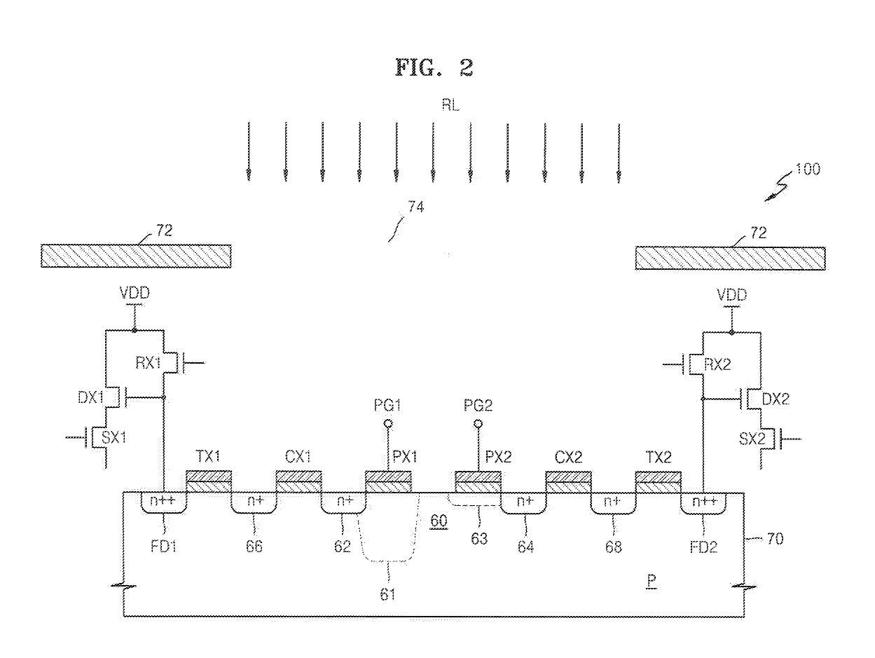

FIG. 2 is a cross-sectional view of the depth-sensing pixel of FIG. 1 integrated in a semiconductor device, according to an exemplary embodiment of the inventive concept.

Referring to FIG. 2, the photoelectric conversion region 60 for generating EHPs by receiving reflected light (RL, as an amplitude modulated optical signal) from a target object is formed in a first-conductive-type, e.g., p-type, semiconductor substrate 70. The first and second photoelectric conversion devices PX1 and PX2 are formed in the photoelectric conversion region 60 and their respective gates PG1 and PG2 are formed apart from each other on the photoelectric conversion region 60 of the semiconductor substrate 70.

Electron storage regions 62 and 64 are provided for accumulating electrons separated from the EHPs by the first and second photoelectric conversion devices PX1 and PX2. Electron storage regions 62 and 64 are highly doped second-conductive-type, e.g., n+-type regions and, are formed by a second-type dopant being diffused into a portion of the surface of the semiconductor substrate 70. Electron storage regions 66 and 68 are formed apart from the electron storage regions 62 and 64, respectively. High-density second-conductive-type, e.g., n+-type, electron storage regions 66 and 68 are also formed by a second-type dopant being diffused into the surface of the semiconductor substrate 70. Gate electrodes of the first and second capture transistors CX1 and CX2 are formed on the semiconductor substrate 70 and between the electron storage regions 62 and 66 and between the electron storage regions 64 and 68, respectively.

In addition, high-density second-conductive-type, e.g., n++-type, first and second floating diffusion regions FD1 and FD2 are formed by a second-type dopant being diffused into the surface of the semiconductor substrate 70 and are formed apart from the electron storage regions 66 and 68, respectively. Gate electrodes of the first and second transfer transistors TX1 and TX2 are formed on the semiconductor substrate 70, between the electron storage region 66 and the first floating diffusion region FD1 and between the electron storage region 68 and the second floating diffusion region FD2, respectively.

The photoelectric conversion region 60 can generate EHPs by receiving reflected light RL. The first and second gate signals PG1 and PG2 are applied to the first and second photoelectric conversion devices PX1 and PX2, respectively. The first and second gate signals PG1 and PG2 are applied as pulse voltages having different phases (see timing diagram FIG. 5). For example, first and second gate signals PG1 and PG2 may have a phase difference of 180°.

When a voltage of about 2 V to about 3 V, (logic HIGH) is applied to the first gate signal PG1, a large depletion region 61 is formed below the first photoelectric conversion device PX1 in the photoelectric conversion region 60. In this case, electrons of the EHPs generated by using the reflected light RL move to the electron storage region 62 through the depletion region 61 and are stored (accumulated) in the electron storage region 62. At this time, a ground voltage VSS (logic LOW) is applied to the second gate signal PG2, and accordingly, the depletion region 63 is minimally or not at all formed below the second photoelectric conversion device PX2 in the photoelectric conversion region 60.

Likewise, when a voltage of about 2 V to about 3 V (logic HIGH) is applied to the second gate signal PG2, a large depletion region 63 may be formed below the second photoelectric conversion device PX2 in the photoelectric conversion region 60. In this case, electrons of the EHPs generated by the reflected light RL move to the electron storage region 64 through the depletion region 63 and are stored (accumulated) in the electron storage region 64. At this time, the ground voltage VSS (logic LOW) is applied to the first gate signal PG1, and accordingly, the depletion region 61 is minimally or not at all formed below the first photoelectric conversion device PX1 in the photoelectric conversion region 60.

When the voltage of the first gate signal PG1 repeatedly (and alternately) goes logic HIGH and logic LOW and the voltage of the first capture signal CG1 is logic HIGH, the electrons temporarily stored in the electron storage region 62 become cumulatively stored in the electron storage region 66. In addition, when the voltage of the second gate signal PG2 repeatedly (and alternately) goes logic HIGH and logic LOW and the voltage of the second capture signal CG2 is logic HIGH, the electrons temporarily stored in the electron storage region 64 become cumulatively stored in the electron storage region 68. A more detailed description of the operation of the depth-sensing pixel 100 will be described below with reference to the timing diagram of FIG. 5.

The depth-sensing pixel 100 further includes the electron storage regions 66 and 68 in addition to the first and second capture transistors CX1 and CX2, and thus the operation of accumulating the electrons generated by the first and second photoelectric conversion devices PX1 and PX2 is distinguished from the operation of transferring the accumulated electrons to the first and second floating diffusion regions FD1 and FD2 via the first and second transfer transistors TX1 and TX2, and accordingly, the depth-sensing pixel 100 can provide a clear signal of high stability free of most kTC noise.

The depth-sensing pixel 100 can quickly transfer the electrons stored in the electron storage regions 66 and 68 to the first and second floating diffusion regions FD1 and FD2 by including different impurity densities of the sources and drains of the first and second transfer transistors TX1 and TX2. Thus, the depth-sensing pixel 100 can provide a clear signal of high stability free of most kTC noise.

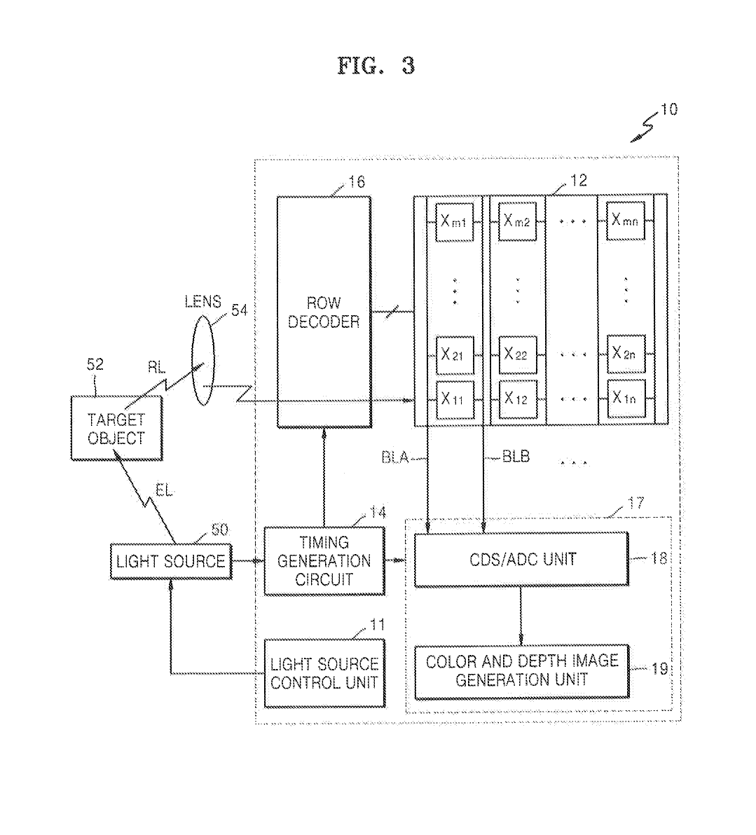

FIG. 3 is a block diagram of a 3D image sensor 10, including an array of depth-sensing pixels of FIG. 1, according to an exemplary embodiment of the inventive concept.

Referring to FIG. 3, modulated light EL emitted from a light source 50 as a periodic-pulse signal is reflected by a target object 52, and the reflected light RL is incident to the array 12 of pixels 100 in a depth-sensing image sensor 10 through a lens 54. The light source 50 is a device capable of high-speed light modulation, and may be implemented with one or more light-emitting diode (LED)s d. The pixels 100 in the array 12 of the image sensor 10 receive the reflected incident repeated-pulse signal (an optical signal) and converts a time-delimited portion of the received optical signal to generate a depth image of the target object 52.

The image sensor 10 includes a light source control unit 11, a pixel array 12, a timing generation circuit 14, a row decoder 16, and an image processing unit 17. The image sensor 10 may be applied to various application fields of endeavor including digital cameras, camcorders, multimedia devices, optical communication (including optical fiber and free space), laser detection and ranging (LADAR), infrared microscopes, infrared telescopes, body heat image diagnosis devices. Body heat image diagnosis devices are medical systems in medical science for outputting medical information related to the presence/absence or a grade of a disease and for preventing the disease by measuring, processing, and analyzing a minute temperature change on the surface of the human body without applying any pain or burden to the human body. The image sensor 10 may also be applied to environment monitoring systems, such as an unmanned forest fire monitoring device, a sea contamination monitoring device, and so forth, temperature monitoring systems in semiconductor process lines, building insulation and water-leakage detection systems, electrical and electronic printed circuit board (PCB) circuit and parts inspection systems, and so forth.

The light source control unit 11 controls the light source 50 and adjusts the frequency (period) of the repeated-pulse signal.

The pixel array 12 includes a plurality of pixels 100 labeled Xᵢⱼ (i=1˜m, j=1˜n) arranged in a two-dimensional matrix type along rows and columns and forms a rectangular-shaped image capture area. Each of the plurality of pixels 100 Xᵢⱼ (i=1˜m, j=1˜n) is accessed by a combination of a row address and a column address. Each of the plurality of pixels 100 Xᵢⱼ (i=1˜m, j=1˜n) includes at least one (and preferably at least two) photoelectric conversion devices implemented by a photodiode, a phototransistor, a photoelectric conversion device or a pinned photodiode. Each of the photoelectric conversion devices in the plurality of pixels 100 Xᵢⱼ (i=1˜m, j=1˜n) may further have an associated transfer transistor, a drive transistor, a selection transistor, and a reset transistor connected to the photoelectric conversion device as illustrated in FIGS. 1 and 2. According to an exemplary embodiment of the inventive concept, each of the plurality of pixels Xᵢⱼ (i=1˜m, j=1˜n) further includes a capture transistor for each photoelectric conversion device. Pixel signals output from the plurality of photoelectric conversion devices in the pixels 100 Xᵢⱼ (i=1˜m, j=1˜n) are output through bit lines BLA, BLB, . . . .

The timing generation circuit 14 controls the operation timing of the row decoder 16 and the image processing unit 17. The timing generation circuit 14 provides a timing signal and a control signal to the row decoder 16 and to the image processing unit 17.

The row decoder 16 generates driving signals for sequentially or otherwise driving the many rows of the pixel array 12, e.g., a capture signal CG, a transfer signal TG, a reset signal RG, a selection signal SEL, and so forth, and the first and second gate signals PG1 and PG2. The row decoder 16 selects each of the plurality of pixels Xᵢⱼ (i=1˜m, j=1˜n) of the pixel array 12 in row units in response to the driving signals and the first and second gate signals PG1 and PG2.

The image processing unit 17 generates a color image and also a depth image from the pixel signals output from the plurality of pixels 100 Xᵢⱼ (i=1˜m, j=1˜n). The image processing unit 17 may include a correlated double sampling (CDS) and analog digital converter (ADC) unit 18 and a color and depth image generation unit 19.

The CDS/ADC unit 18 can remove noise by correlated-double-sampling pixel signals corresponding to a selected row, which pixel signals are transferred to the bit lines BLA, BLB, . . . of the pixel array 12. The CDS/ADC unit 18 compares pixel signals from which noise has been removed with a ramp signal output from a ramp generator (not shown). The CDS/ADC unit 18 converts a pixel 100 signal output, as a digital pixel signal having multiple bits.

The color and depth image generation unit 19 generates a color image and a depth image by calculating color information and depth information of each corresponding pixel 100 based on the digital pixel signals output by the CDS/ADC unit 18.

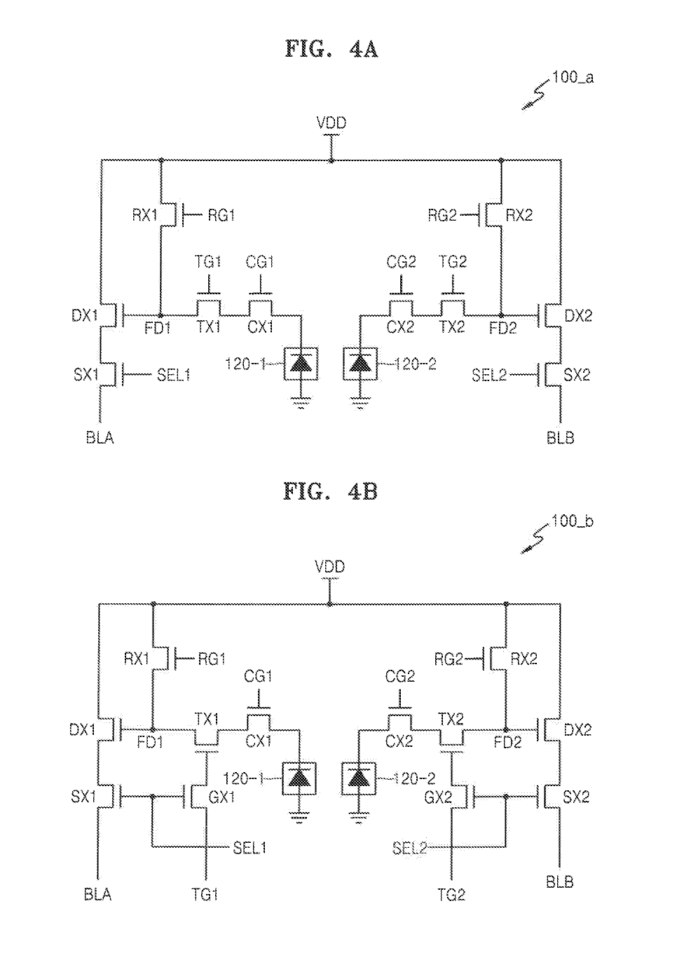

FIG. 4A is an equivalent circuit diagram of an exemplary implementation 100_{—}a of one depth-sensing pixel 100 (an array 12 of which may be included in a 3D image sensor 10), according to an exemplary embodiment of the inventive concept.

Referring to FIG. 4A, the depth-sensing pixel 100_{—}a has a two-tap pixel structure in which two photoelectric conversion devices 120-1 & 120-2 are formed spatially close together but distinct from each other in a photoelectric conversion region. Each of the two photoelectric conversion devices 120-1 & 120-2 is a light-sensing device and can be implemented by a photodiode, a phototransistor, a photoelectric conversion device, or a pinned photodiode. The depth-sensing pixel 100_{—}a includes the first and second capture transistors CX1 and CX2 (connected to the two photoelectric conversion devices 120-1 & 120-2 respectively), the first and second transfer transistors TX1 and TX2, the first and second drive transistors DX1 and DX2, the first and second selection transistors SX1 and SX2, and the first and second reset transistors RX1 and RX2.

Each of the two photoelectric conversion devices 120-1 & 120-2 generates electron-hole pairs (EHPs). A depletion region can be formed in each of the two photoelectric conversion devices 120-1 & 120-2. The electrons and a holes of the EHPs are separated by the depletion region.

In the first capture transistor CX1, the first capture signal CG1 is applied to the gate thereof, the first photoelectric conversion device 120-1 is connected to the drain thereof, and the first transfer transistor TX1 is connected to the source thereof. The first capture transistor CX1 transfers electrons in the first photoelectric conversion device 120-1 to an electron storage region of the first transfer transistor TX1 in response to the first capture signal CG1. In response to the first capture signal CG1, the first capture transistor CX1 alternately electrically connects the first photoelectric conversion device 120-1 to the first transfer transistor TX1 and electrically cuts off the first photoelectric conversion device 120-1 and the first transfer transistor TX1 from each other.

In the first transfer transistor TX1, the first transfer signal TG is applied to the gate thereof, the first capture transistor CX1 is connected to the drain thereof, and the first floating diffusion region FD1 is connected to the source thereof. In response to the first transfer signal TG1, the first transfer transistor TX1 transfers the accumulated electrons received through the first capture transistor CX1. The first transfer transistor TX1 alternately electrically connects the first capture transistor CX to the first floating diffusion region FD1 and electrically cuts off the first capture transistor CX1 and the first floating diffusion region FD1 from each other.

In the first drive transistor DX1, the first floating diffusion region FD1 is applied to the gate thereof, the power source voltage VDD is connected to the drain thereof, and the first selection transistor SX1 is connected to the source thereof. The voltage of the source terminal of the first drive transistor DX1 is determined by the voltage of the first floating diffusion region FD1. The voltage of the first floating diffusion region FD1 is determined by the amount of accumulated electrons transferred from the first photoelectric conversion device 120-1.

In the first selection transistor SX1, the first selection signal SEL1 (a row control signal) is applied to the gate thereof, the source of the first drive transistor DX1 is connected to the drain thereof, and the first bit line BLA in the pixel array 12 is connected to the source thereof. An analogue pixel voltage signal is output through the first bit line BLA.

In the first reset transistor RX1, the first reset signal RG1 is applied to the gate thereof, the power source voltage VDD is connected to the drain thereof, and the first floating diffusion region FD1 is connected to the source thereof. When the first reset signal RG1 is enabled after a pixel information detection process is performed based on the voltage of the first floating diffusion region FD1, the first reset transistor RX1 resets the voltage of the first floating diffusion region FD1 to the power source voltage VDD.

In the second capture transistor CX2, the second capture signal CG2 is applied to the gate thereof, the other (second) one of the photoelectric conversion devices (120-2) is connected to the drain thereof, and the second transfer transistor TX2 is connected to the source thereof. The second capture transistor CX2 hold accumulated electrons in a lower portion of the second photoelectric conversion device 120-2 or transfers the accumulated electrons to the second transfer transistor TX2 in response to the second capture signal CG2. In response to the second capture signal CG2, the second capture transistor CX2 alternately electrically connects the second photoelectric conversion device 120-2 to the second transfer transistor TX2 and electrically cuts off the second photoelectric conversion device 120-2 and the second transfer transistor TX2 from each other.

In the second transfer transistor TX2, the second transfer signal TG2 is applied to the gate thereof, the second capture transistor CX2 is connected to the drain thereof, and the second floating diffusion region FD2 is connected to the source thereof. The second transfer transistor TX2 can transfer the accumulated electrons received through the second capture transistor CX2 in response to the second transfer signal TG2. In response to the second transfer signal TG2, the second transfer transistor TX2 alternately electrically connects the second capture transistor CX2 to the second floating diffusion region FD2 and electrically cuts off the second capture transistor CX2 and the second floating diffusion region FD2 from each other.

In the second drive transistor DX2, the second floating diffusion region FD2 is applied to the gate thereof, the power source voltage VDD is connected to the drain thereof, and the second selection transistor SX2 is connected to the source thereof. The voltage of the source terminal of the second drive transistor DX2 is determined by the voltage of the second floating diffusion region FD2. The voltage of the second floating diffusion region FD2 is determined by the amount of the accumulated electrons transferred from the second photoelectric conversion device 120-2.

In the second selection transistor SX2, the second selection signal SEL2 (a row control signal) is applied to the gate thereof, the source of the second drive transistor DX2 is connected to the drain thereof, and the second bit line BLB in the pixel array 12 is connected to the source thereof. An analog pixel voltage signal is output through the second bit line BLB.

In the second reset transistor RX2, the second reset signal RG2 is applied to the gate thereof, the power source voltage VDD is connected to the drain thereof, and the second floating diffusion region FD2 is connected to the source thereof. When the second reset signal RG2 is enabled after a pixel information detection process is performed based on the voltage of the second floating diffusion region FD2, the second reset transistor RX2 resets the voltage of the second floating diffusion region FD2 to the power source voltage VDD.

Accordingly, since the operations of accumulating the electrons generated by the two photoelectric conversion devices 120-1 & 120-2 is distinct from the operations of transferring the accumulated electrons to the first and second floating diffusion regions FD1 and FD2 via the first and second transfer transistors TX1 and TX2 in the depth-sensing pixel 100_{—}a, the depth-sensing pixel 100_{—}a may provide a clear signal of high stability free of most kTC noise.

FIG. 4B is an equivalent circuit diagram corresponding to an exemplary implementation 100_{—}b of a depth-sensing pixel 100 included in the array 12 of a 3D image sensor 10, according to an exemplary embodiment of the inventive concept.

Referring to FIG. 4B, the depth-sensing pixel 100_{—}b has a two-tap pixel structure in which two photoelectric conversion devices 120-1 & 120-2 are formed in a photoelectric conversion region. Each of the two photoelectric conversion devices 120-1 & 120-2 is a light-sensing device and may be implemented by a photodiode, a phototransistor, a photoelectric conversion device, or a pinned photodiode. The depth-sensing pixel 100_{—}b includes the first and second capture transistors CX1 and CX2 connected to the two photoelectric conversion devices 120-1 & 120-2, the first and second transfer transistors TX1 and TX2, first and second control transistors GX1 and GX2, the first and second drive transistors DX1 and DX2, the first and second selection transistors SX1 and SX2, and the first and second reset transistors RX1 and RX2.

Each of the two photoelectric conversion devices 120-1 & 120-2 generates an EHPs by using detected light. A depletion region can be formed in each of the two photoelectric conversion devices 120-1 & 120-2. The electrons and the holes in the EHP are separated by the depletion region.

In the first capture transistor CX1, the first capture signal CG1 is applied to the gate thereof, the first photoelectric conversion device 120-1 is connected to the drain thereof, and the first transfer transistor TX1 is connected to the source thereof. In response to the first capture signal CG1, the first capture transistor CX1 can transfer electrons accumulated in the first photoelectric conversion devices 120-1 to an electron storage region of the first transfer transistor TX1. In response to the first capture signal CO1, the first capture transistor CX1 alternately electrically connects the first photoelectric conversion device 120-1 to the first transfer transistor TX1 and electrically cuts off the first photoelectric conversion device 120-1 and the first transfer transistor TX1 from each other.

In the first transfer transistor TX1, the drain of the first control transistor GX1 is applied to the gate thereof, the first capture transistor CX1 is connected to the drain thereof, and the first floating diffusion region FD1 is connected to the source thereof. The first transfer transistor TX1 can transfer the electrons received through the first capture transistor CX1 in response to the first transfer signal TG1 provided through the first control transistor GX1. In response to the first transfer signal TG1, the first transfer transistor TX1 can (alternately) electrically connect the first capture transistor CX1 to the first floating diffusion region FD1 or electrically cut off the first capture transistor CX1 and the first floating diffusion region FD1 from each other in response to the first transfer signal TG1.

In the first control transistor GX1, the first selection signal SEL1 is applied to the gate thereof, the gate of the first transfer transistor TX1 is connected to the drain thereof, and the first transfer signal TG1 is connected to the source thereof. The first control transistor GX1 provides the first transfer signal TG1 to the gate of the first transfer transistor TX1 in response to the first selection signal SEL 1.

In the first drive transistor DX1, the first floating diffusion region FD1 is connected to the gate thereof, the power source voltage VDD is connected to the drain thereof and the first selection transistor SX1 is connected to the source thereof. The voltage of the source terminal of the first drive transistor DX1 is determined by the voltage of the first floating diffusion region FD1. The voltage of the first floating diffusion region FD1 is determined by the amount of the accumulated electrons transferred from the second photoelectric conversion device 120-2.

In the first selection transistor SX1, the first selection signal SEL1 (a row control signal) is applied to the gate thereof, the source of the first drive transistor DX1 is connected to the drain thereof, and the first bit line BLA in the pixel array 12 is connected to the source thereof. An analog pixel voltage signal is output through the first bit line BLA.

In the first reset transistor RX1, the first reset signal RG1 is applied to the gate thereof, the power source voltage VDD is connected to the drain thereof, and the first floating diffusion region FD1 is connected to the source thereof. When the first reset signal RG1 is enabled after a pixel information detection process is performed based on the voltage of the first floating diffusion region FD1, the first reset transistor RX1 resets the voltage of the first floating diffusion region FD1 to the power source voltage VDD.

In the second capture transistor CX2, the second capture signal CG2 is applied to the gate thereof, the second photoelectric conversion device 120-2 is connected to the drain thereof, and the second transfer transistor TX2 is connected to the source thereof. In response to the second capture signal CG2, the second capture transistor CX2 alternately holds electrons in a lower portion of the second photoelectric conversion device 120-2 and transfers the electrons to the second transfer transistor TX2. The second capture transistor CX2 can electrically connect the second photoelectric conversion device 120-2 to the second transfer transistor TX2 and electrically cut off the other one of the photoelectric conversion devices 120-1 & 120-2 and the second transfer transistor TX2 from each other in response to the second capture signal CG2.

In the second transfer transistor TX2, the drain of the second control transistor GX2 is applied to the gate thereof, the second capture transistor CX2 is connected to the drain thereof, and the second floating diffusion region FD2 is connected to the source thereof. The second transfer transistor TX2 may transfer the electrons received through the second capture transistor CX2 in response to the second transfer signal TG2 provided through the second control transistor GX2. The second transfer transistor TX2 may electrically connect the second capture transistor CX2 to the second floating diffusion region FD2 or electrically cut off the second capture transistor CX2 and the second floating diffusion region FD2 from each other in response to the second transfer signal TG2.

In the second control transistor GX2, the second selection signal SEL2 is applied to the gate thereof, the gate of the second transfer transistor TX2 is connected to the drain thereof, and the second transfer signal TG2 is connected to the source thereof. The second control transistor GX2 provides the second transfer signal TG2 to the gate of the second transfer transistor TX2 in response to the second selection signal SEL2.

In the second drive transistor DX2, the second floating diffusion region FD2 is connected to the gate thereof, the power source voltage VDD is connected to the drain thereof, and the second selection transistor SX2 is connected to the source thereof. The voltage of the source terminal of the second drive transistor DX2 is determined by the voltage of the second floating diffusion region FD2. The voltage of the second floating diffusion region FD2 is determined by the amount of the accumulated electrons transferred from the second photoelectric conversion device 120-2.

In the second selection transistor SX2, the second selection signal SEL2 (a row control signal) is applied to the gate thereof, the source of the second drive transistor DX2 is connected to the drain thereof, and the second bit line BLB in the pixel array 12 is connected to the source thereof. An analog pixel voltage signal is output through the second bit line BLB.

In the second reset transistor RX2, the second reset signal RG2 is applied to the gate thereof, the power source voltage VDD is connected to the drain thereof, and the second floating diffusion region FD2 is connected to the source thereof. When the second reset signal RG2 is enabled after a pixel information detection process is performed based on the voltage of the second floating diffusion region FD2, the second reset transistor RX2 resets the voltage of the second floating diffusion region FD2 to the power source voltage VDD.

Accordingly, since the operations of accumulating the electrons generated by the two photoelectric conversion devices 120-1 & 120-2 are distinct from the operations of transferring the accumulated electrons to the first and second floating diffusion regions FD1 and FD2 via the first and second transfer transistors TX1 and TX2 in the depth-sensing pixel 100_{—}b, the depth-sensing pixel 100_{—}b can provide a clear signal of high stability free of most kTC noise.

FIG. 5 is a timing diagram for describing a method operation of the depth-sensing pixels 100, 100_{—}a, or 100_{—}b of FIG. 1, 4A, or 4B, according to an embodiment of the inventive concept.

Referring to FIGS. 1 and 5, upon exposure to light, the photoelectric conversion region 60 generates electrons. The generated electrons may be cumulatively stored in electron storage regions of the first capture transistor CX1 and the first transfer transistor TX1 if a voltage of the first gate signal PG1 repeatedly (periodically, alternately) goes logic HIGH and logic LOW and if the first capture signal CG1 is logic HIGH.

For correlated double sampling, before signal-level sampling, reset-level sampling is first performed by setting the first reset signal RG1 as ON in a state where the first capture signal CG1 is logic HIGH.

If the first capture transistor CX1 is turned OFF immediately before the signal-level sampling, and if the first transfer transistor TX1 is turned ON for a predetermined period of time, then the accumulated electrons move to the first floating diffusion region FD1. Since the first capture transistor CX 1 is turned OFF, the electrons generated by the first photoelectric conversion device PX1 do not immediately move to the first floating diffusion region FD1.

The signal-level sampling is performed, and the true magnitude of the pixel signal is measured by comparing the signal-level sampling with the reset-level sampling.

If the voltage of the second gate signal PG2 repeatedly goes logic LOW and logic HIGH and the second capture signal CG2 is logic HIGH, electrons may be cumulatively stored in electron storage regions of the second capture transistor CX2 and the second transfer transistor TX2.

Before signal-level sampling, reset-level sampling is first performed by setting the second reset signal RG2 as ON in a state where the second capture signal CG2 is logic HIGH.

If the second capture transistor CX2 is turned OFF immediately before the signal-level sampling, and if the second transfer transistor TX2 is turned ON for a predetermined period of time, the accumulated electrons move to the second floating diffusion region FD2. Since the second capture transistor CX2 is turned OFF, the electrons generated by the second photoelectric conversion device PX2 do not immediately move to the second floating diffusion region FD2.

The signal-level sampling is performed, and the true magnitude of a pixel signal is measured by comparing the signal-level sampling with the reset-level sampling.

Operations of the depth-sensing pixels 100_{—}a and 100_{—}b of FIGS. 4A and 4B are also similar to the operation of the depth-sensing pixel 100 of FIG. 1.

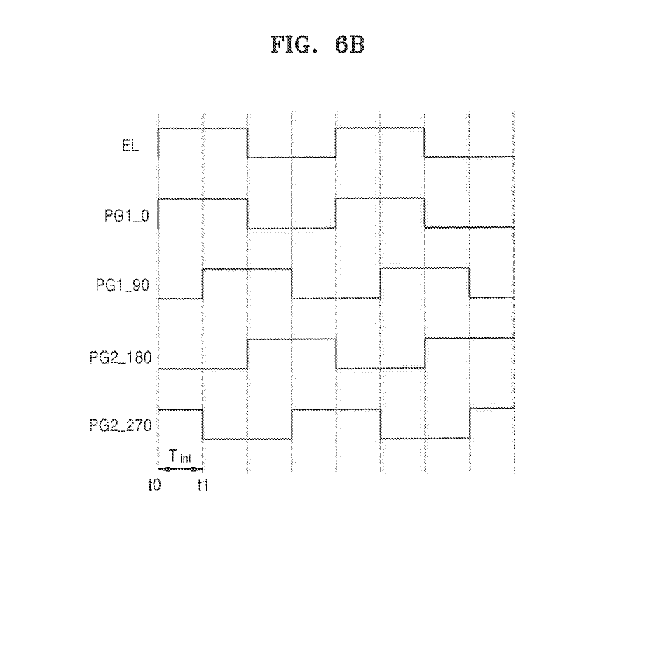

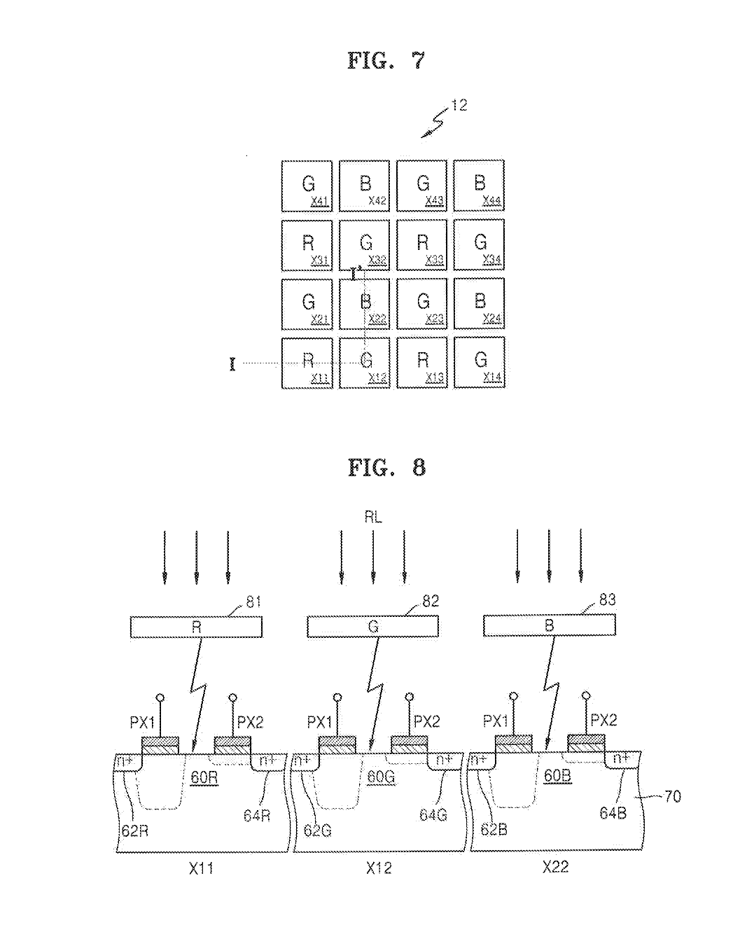

FIG. 6A is a graph for describing the operation of a pixel's calculating of depth information by using the first and second photoelectric conversion devices PX1 and PX2 of FIG. 1, according to an embodiment of the inventive concept.

Referring to FIG. 6A, the modulated light EL emitted as repeated pulses from the light source 50 and the reflected light RL reflected from the target object 52 and incident to the depth-sensing pixel 100 are shown. For convenience of description, the modulated light EL is described with repeated pulses in a sine wave form. Tᵢₙₜ denotes an integral time period, i.e., the time light is emitted. A phase difference \hat{θ} indicates the time taken until the emitted modulated light EL is reflected by the target object 52 and the reflected light RL is detected by the image sensor 10. Distance information or depth information between the target object 52 and the image sensor 10 may be calculated from the phase difference \hat{θ}.

The first gate signal PG1 applied to the first photoelectric conversion device PX1 and the second gate signal PG2 applied to the second photoelectric conversion device PX2 have a phase difference of 180°. A first pixel's accumulated charge A′0 to be accumulated in the electron storage region 62 in response to the first gate signal PG1 is indicated by a shaded area in which the first gate signal PG1 and the reflected light RL overlap each other. A second pixel signal's accumulate charge A′2 to be accumulated in the electron storage region 64 in response to the second gate signal PG2 may be indicated by a shaded area in which the second gate signal PG2 and the reflected light RL overlap each other. The first pixel's accumulated charge A′0 and the second pixel's accumulated charge A′2 may be represented by Equation 1.

$${A}^{′} 0 = {\sum }_{n = 1}^{N} ( a 0 , n ) \\ {A}^{′} 2 = {\sum }_{n = 1}^{N} ( a 2 , n ) \qquad ( 1 )$$

In Equation 1, a0,n denotes the number of electrons generated by the depth-sensing pixel 100 while the first gate signal PG1 having a phase difference of 0° with respect to the emitted modulated light EL is applied n times (n is a natural number), a2,n denotes the number of electrons generated by the depth-sensing pixel 100 while the second gate signal PG2 having a phase difference of 180° with respect to the emitted modulated light EL is applied n times (n is a natural number), and N denotes a value obtained by multiplying a frequency fm of the modulated light EL by the integral time Tᵢₙₜ, i.e., N=fm*Tᵢₙₜ.

FIG. 6B is a timing diagram for describing the operations of calculating depth information by the first and second photoelectric conversion devices PX1 and PX2 of FIG. 1, according to another embodiment of the inventive concept.

Referring to FIG. 6B, the modulated light EL emitted from the light source 50 is shown. For convenience of description, it is described that the modulated light EL has repeated pulses in a square wave form. First and third gate signals PG1_0 and PG2_180 having a phase difference of 180° therebetween are applied to the first and second photoelectric conversion devices PX1 and PX2, respectively, and second and fourth gate signals PG1_90 and PG2_270 having a phase difference of 180° therebetween are applied to the first and second photoelectric conversion devices PX1 and PX2, respectively. The first to fourth gate signals PG1_0, PG1_90, PG2_180 and PG2_270 are sequentially applied with an interval of the integral time Tᵢₙₜ therebetween.

At a first time point t0, a first pixel charge A′0 accumulated in the electron storage region 62 in response to the first gate signal PG1_0 and a third pixel charge A′2 accumulated in the electron storage region 64 in response to the third gate signal PG2_180 are output.

At a second time point t1, a second pixel charge A′1 accumulated in the electron storage region 62 in response to the second gate signal PG1_90 and a fourth pixel charge A′3 accumulated in the electron storage region 64 in response to the fourth gate signal PG2_270 are output. The integral time Tinₜ is between the first time point t0 and the second time point t1.

The first to fourth pixel charges A′0, A′1, A′2, and A′3 may be represented by Equation 2.

$${A}^{′} k = {\sum }_{n = 1}^{N} ( a k , n ) \qquad ( 2 )$$

In Equation 2, ak,n denotes the number of electrons generated by the depth-sensing pixel 100 when an nth gate signal (n is a natural number) is applied with a phase difference corresponding to k, wherein: k=0 when the phase difference with respect to the first gate signal PG1_0 based on the modulated light EL is 0°, k=1 when the phase difference with respect to the second gate signal PG1_90 based on the modulated light EL is 90°, k=2 when the phase difference with respect to the third gate signal PG2_180 based on the modulated light EL is 180°, and k=3 when the phase difference with respect to the fourth gate signal PG2_270 based on the modulated light EL is 270°. N=fm*Tᵢₙₜ, wherein fm denotes a frequency of the modulated light EL, Tᵢₙₜ denotes an integral time.

The first to fourth pixel charges A′0, A′1, A′2, and A′3 are converted to first to fourth digital pixel signals A₀, A₁, A₂, and A₃ by the CDS/ADC unit 18 and transferred to the color and depth image generation unit 19. The color and depth image generation unit 19 generates a color image by calculating color information of a corresponding pixel based on the first to fourth digital pixel signals A₀, A₁, A₂, and A₃. The first to fourth digital pixel signals A₀, A₁, A₂, and A₃ may be simplified by using Equation 3.

A₀=α+β cos θ

A₁=α+β sin θ

A₂=α−β cos θ

A₃=α−β sin θ (3)

In Equation 3, α denotes a background offset, β denotes demodulation intensity indicating the intensity of the reflected light RL.

A phase difference \hat{θ} may be calculated by using Equation 4.

$$\hat{θ} = 2 π {f}_{m} {t}_{Δ} = {tan}^{- 1} \frac{{A}_{1} - {A}_{3}}{{A}_{0} - {A}_{2}} \qquad ( 4 )$$

The image sensor 10 can estimate a time difference between when the modulated light is emitted by the light source 50 and when the reflected light RL is incident by being reflected by the target object 52 and the distance d to the target object 52 by using Equation 5.

$${t}_{Δ} = \frac{2 d}{c} \qquad ( 5 )$$

In Equation 5, c denotes the speed of light.

Thus, the color and depth image generation unit 19 may calculate depth information \hat{d} by using Equation 6 as well as Equations 4 and 5.

$$\hat{d} = \frac{c}{4 π {f}_{m}} \hat{θ} \qquad ( 6 )$$

The image sensor 10 of FIG. 3 includes a color filter array of FIG. 7 over the pixel array 12 to acquire a color image.

Referring to FIG. 7, the color filter array is disposed over each pixel Xᵢⱼ (i=1˜m, j=1˜n). The color filter array has a green filter for two pixels in a diagonal direction and red and blue filters for the other two pixels with respect to each 2×2-pixel set. Since human eyes have the highest sensitivity with respect to green, two green filters are used in each 2×2-pixel set. The color filter array is called a Bayer pattern.

Pixels marked as “R” perform an operation of obtaining subpixel data related to red, pixels marked as “G” perform an operation of obtaining a subpixel data related to green, and pixels marked as “B” perform an operation of obtaining a subpixel data related to blue.

Although FIG. 7 shows a Bayer pattern based on red, green, and blue, the current embodiment is not limited thereto, and various patterns may be used. For example, a CMY color pattern based on cyan, magenta, and yellow may be used.

FIG. 8 is a cross-sectional view along a section line I-I′ of a portion of the pixel array 12 of FIG. 7, according to an embodiment of the inventive concept. For convenience of description, only the portion of the section line I-I′ in which the reflected light RL is incident to the photoelectric conversion region 60 through an aperture 74 of a light-blocking film 72 of FIG. 2 is shown for each of red, green, and blue pixels X11, X12, and X22.

Referring to FIG. 8, the modulated light EL emitted from the light source 50 is reflected by the target object 52 and is incident as RL to the red, green, and blue pixels X11, X12, and X22. Red reflected light passing through a red filter 81 is incident to a photoelectric conversion region 60R (60) of the red pixel X11. The photoelectric conversion region 60R generates EHPs by using the red reflected light. Green reflected light passing through a green filter 82 is incident to a photoelectric conversion region 600 (60) of the green pixel X12. The photoelectric conversion region 600 generates EHPs by using the green reflected light. Blue reflected light passing through a blue filter 83 is incident to a photoelectric conversion region 60B (60) of the blue pixel X22. The photoelectric conversion region 60B (60) generates EHPs by using the blue reflected light.

In the red pixel X11, the first and third gate signals PG1_0 and PG2_180 having a phase difference of 180° therebetween are applied to the first and second photoelectric conversion devices PX1 and PX2, respectively, and the second and fourth gate signals PG1_90 and PG2_270 having a phase difference of 180° therebetween are applied to the first and second photoelectric conversion devices PX1 and PX2, respectively. The first and third gate signals PG1_0 and PG2_180 and the second and fourth gate signals PG1_90 and PG2_270 are sequentially applied with an interval of the integral time Tᵢₙₜ therebetween.

A first red pixel charge A′_{0,R} accumulated in an electron storage region 62R (i.e., the Red-filtered specimen of storage region 64 in FIG. 2) in response to the first gate signal PG1_0 and a third red pixel charge A′_{2,R} accumulated in an electron storage region 64R (64) in response to the third gate signal PG2_180 are output. After the integral time Tim elapses, the second red pixel charge A′_{1,R} accumulated in the electron storage region 62R (62) in response to the second gate signal PG1_90 and a fourth red pixel charge A′_{3,R} accumulated in the electron storage region 64R (64) in response to the fourth gate signal PG2_270 are output.

The first to fourth red pixel charges A′_{0,R}, A′_{1,R}, A′_{2,R}, and A′_{3,R} from the red pixel X11 may be represented by Equation 7.

A′_{o,R}=α_{R}+β_{R} cos θ_{R}

A′_{1,R}=α_{R}+β_{R} sin θ_{R}

A′_{2,R}=α_{R}−β_{R} cos θ_{R}

A′_{3,R}=α_{R}−β_{R} sin θ_{R} (4)

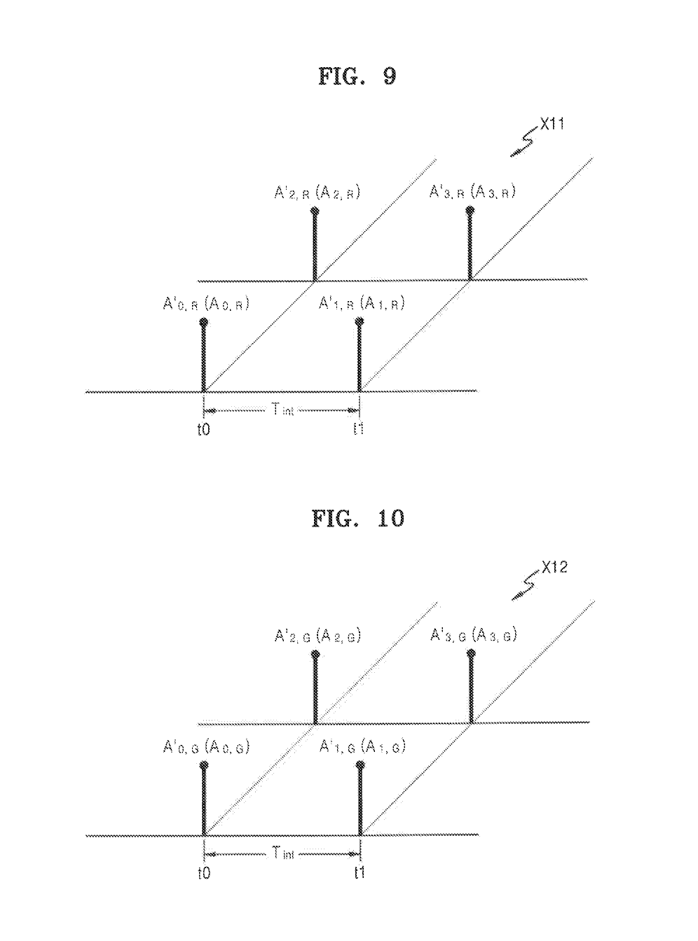

In Equation 7, a red color value of the red pixel X11 may be extracted by signal-processing a background offset component of α_{R} or a demodulation intensity component β_{R}. The first to fourth red pixel charge A′_{0,R}, A′_{1,R}, A′_{2,R}, and A′_{3,R} from the red pixel X11 are output according to the timing as shown in FIG. 9.

Referring to FIG. 9, when the first and third gate signals PG1_0 and PG2_180 having a phase difference of 180° therebetween are supplied to the red pixel X11 at the first time point t0 as shown in FIG. 6B, the red pixel X11 outputs the first and third red pixel charges A′_{0,R} and A′_{2,R} that are simultaneously measured. When the second and fourth gate signals PG1_90 and PG2_270 having a phase difference of 180° therebetween are supplied to the red pixel X11 at the second time point t1, the red pixel X11 outputs the second and fourth red pixel charges A′_{1,R} and A′_{3,R} that are simultaneously measured. The integral time Tin exists between the first time point t0 and the second time point t1.

Since the red pixel X11 cannot simultaneously measure the first to fourth red pixel charge A′_{0,R}, A′_{1,R}, A′_{2,R}, and A′_{3,R}, the red pixel X11 measures two other red pixel charge at two times with a time difference Tᵢₙₜ therebetween.

The first to fourth red pixel charges A′_{0,R}, A′_{1,R}, A′_{2,R}, and A′_{3,R} are converted to first to fourth digital red pixel signals A_{0,R}, A_{1,R}, A_{2,R}, and A_{3,R} by the CDS/ADC unit 18. The color and depth image generation unit 19 generates a color image by calculating red color information C_{R} of the red pixel X11 based on the first to fourth digital red pixel signals A_{0,R}, A_{1,R}, A_{2,R}, and A_{3,R}.

The color and depth image generation unit 19 calculates the red color information C_{R} by summing the first to fourth digital red pixel signals A_{0,R}, A_{1,R}, A_{2,R}, and A_{3,R} of the red pixel X11 by using Equation 8.

C_{R}=A_{0,R}+A_{1,R}+A_{2,R}+A_{3,R} (8)

The color and depth image generation unit 19 may estimate the phase difference \hat{θ}_{R} of the red pixel X11 from the first to fourth digital red pixel signals A_{0,R}, A_{1,R}, A_{2,R}, and A_{3,R} of the red pixel X11 by using Equation 9.

$${θ}_{R} = 2 π {f}_{m} {t}_{Δ , R} = {tan}^{- 1} \frac{{A}_{1 , R} - {A}_{3 , R}}{{A}_{0 , R} - {A}_{2 , R}} \qquad ( 9 )$$

Accordingly, the color and depth image generation unit 19 calculates depth information \hat{d}_{R} of the red pixel X11 by using Equation 10.

$${\hat{d}}_{R} = \frac{c}{4 π {f}_{m}} {\hat{θ}}_{R} \qquad ( 10 )$$

In the green pixel X12 of FIG. 8, the first and third gate signals PG1_0 and PG2_180 having a phase difference of 180° therebetween are applied to the first and second photoelectric conversion devices PX1 and PX2, respectively, and the second and fourth gate signals PG1_90 and PG2_270 having a phase difference of 180° therebetween are applied to the first and second photoelectric conversion devices PX1 and PX2, respectively. The first and third gate signals PG1_0 and PG2_180 and the second and fourth gate signals PG1_90 and PG2_270 are sequentially applied with an interval of the integral time Tinₜ therebetween.

A first green pixel charge A′_{0,G} accumulated in an electron storage region 62G in response to the first gate signal PG1_0 and a third green pixel charge A′_{2,G} accumulated in an electron storage region 64G in response to the third gate signal PG2_180 are output. After the integral time Tᵢₙₜ elapses, a second green pixel charge A′_{1,G} accumulated in the electron storage region 62G in response to the second gate signal PG1_90 and a fourth green pixel charge A′_{3,G} accumulated in the electron storage region 64G in response to the fourth gate signal PG2_270 are output.

The first to fourth green pixel charge A′_{0,G}, A′_{1,G}, A′_{2,G}, and A′_{3,G} from the green pixel X12 may be represented by Equation 11.

A′_{o,G}=α_{G}+β_{G} cos θ_{G}

A′_{1,G}=α_{G}+β_{G} sin θ_{G}

A′_{2,G}=α_{G}−β_{G} cos θ_{G}

A′_{3,G}=α_{G}−β_{G} sin θ_{G} (11)

In Equation 11, a green color value of the green pixel X12 may be extracted by signal-processing a background offset component α_{G} or a demodulation intensity component β_{G}. The first to fourth green pixel charges A′_{0,G}, A′_{1,G}, A′_{2,G}, and A′_{3,G} from the green pixel X12 are output according to the timing as shown in FIG. 10.

Referring to FIG. 10, when the first and third gate signals PG1_0 and PG2_180 having a phase difference of 180° therebetween are supplied to the green pixel X12 at the first time point t0 as shown in FIG. 6B, the green pixel X12 outputs the first and third green pixel charges A′_{0,G} and A′_{2,G} that are simultaneously measured. When the second and fourth gate signals PG1_90 and PG2_270 having a phase difference of 180° therebetween are supplied to the green pixel X12 at the second time point t1, the green pixel X12 outputs the second and fourth green pixel charges A′_{1,G f} and A′_{3,G} that are simultaneously measured. The integral time Tᵢₙₜ exists between the first time point t0 and the second time point t1.

Since the green pixel X12 cannot simultaneously measure the first to fourth green pixel charges A′_{0,G}, A′_{1,G}, A′_{2,G}, and A′_{3,G}, the green pixel X12 measures two pixels charges at a times two times with a time difference Tᵢₙₜ therebetween.

The first to fourth green pixel charges A′_{0,G}, A′_{1,G}, A′_{2,G}, and A′_{3,G} are converted to first to fourth digital green pixel signals A_{0,G}, A_{1,G}, A_{2,G}, and A_{3,G} by the CDS/ADC unit 18. The color and depth image generation unit 19 generates a color image by calculating green color information C_{G} of the green pixel X12 based on the first to fourth digital green pixel signals A_{0,G}, A_{1,G}, A_{2,G}, and A_{3,G}.

The color and depth image generation unit 19 calculates the green color information C_{G} by summing the first to fourth digital green pixel signals A_{0,G}, A_{1,G}, A_{2,G}, and A_{3,G} of the green pixel X12 by using Equation 12.

C_{G}=A_{0,G}+A_{1,G}+A_{2,G}+A_{3,G} (12)

The color and depth image generation unit 19 can estimate the phase difference \hat{θ}_{G} of the green pixel X12 from the first to fourth digital green pixel signals A_{0,G}, A_{1,G}, A_{2,G}, and A_{3,G} of the green pixel X12 by using Equation 13.

$${\hat{θ}}_{G} = 2 π {f}_{m} {t}_{Δ , G} = {tan}^{- 1} \frac{{A}_{1 , G} - {A}_{3 , G}}{{A}_{0 , G} - {A}_{2 , G}} \qquad ( 13 )$$

Accordingly, the color and depth image generation unit 19 calculates depth information \hat{d}_{G} of the green pixel X12 by using Equation 14.

$${\hat{d}}_{G} = \frac{c}{4 π {f}_{m}} {\hat{θ}}_{G} \qquad ( 14 )$$

In the blue pixel X22 of FIG. 8, the first and third gate signals PG1_0 and PG2_180 having a phase difference of 180° therebetween are applied to the first and second photoelectric conversion devices PX1 and PX2, respectively, and the second and fourth gate signals PG1_90 and PG2_270 having a phase difference of 180° therebetween are applied to the first and second photoelectric conversion devices PX1 and PX2, respectively. The first and third gate signals PG1_0 and PG2_180 and the second and fourth gate signals PG1_90 and PG2_270 are sequentially applied with an interval of the integral time Tᵢₙₜ therebetween.

A first blue pixel signal A′_{0,B} accumulated in an electron storage region 62B (i.e., the Blue-filtered specimen of storage region 64 in FIG. 2) in response to the first gate signal PG1_0 and a third blue pixel signal A′_{2,B} accumulated in an electron storage region 64B in response to the third gate signal PG2_180 are output. After the integral time Tᵢₙₜ elapses, a second blue pixel signal A′_{1,B} accumulated in the electron storage region 62B in response to the second gate signal PG1_90 and a fourth green pixel signal A′_{3,B} accumulated in the electron storage region 64B in response to the fourth gate signal PG2_270 are output.

The first to fourth blue pixel charges A′_{0,B}, A′_{1,B}, A′_{2,B}, and A′_{3,B} from the blue pixel X22 may be represented by Equation 15.

A′_{o,B}=α_{B}+β_{B} cos θ_{B}

A′_{1,B}=α_{B}+β_{B} sin θ_{B}

A′_{2,B}=α_{B}−β_{B} cos θ_{B}

A′_{3,B}=α_{B}−β_{B} sin θ_{B} (15)

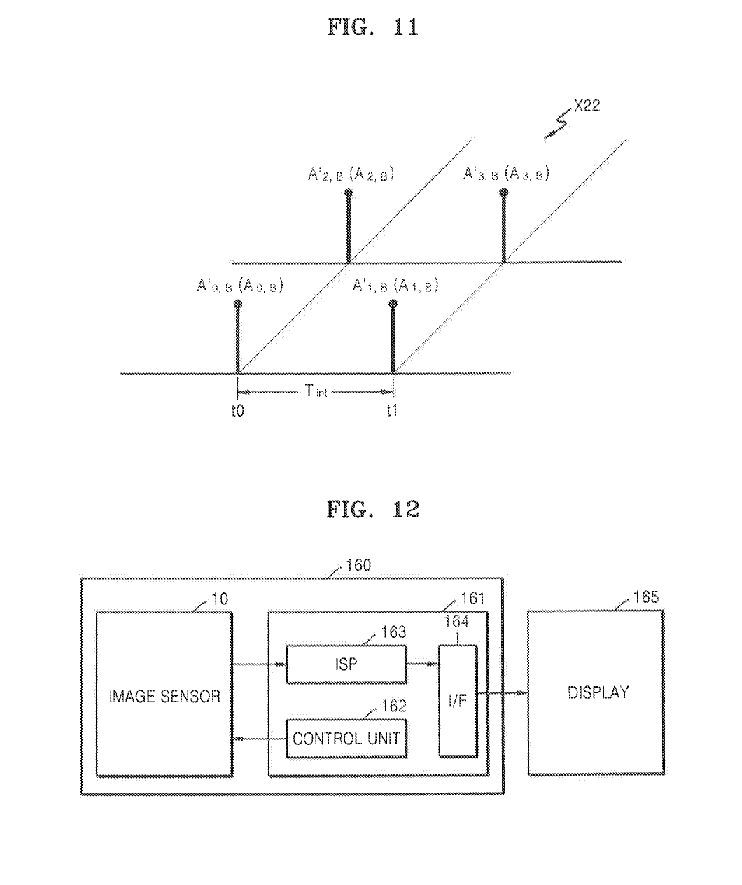

In Equation 15, a blue color value of the blue pixel X22 may be extracted by signal-processing a background offset component ae or a demodulation intensity component β_{B}. The first to fourth blue pixel charges A′_{0,B}, A′_{1,B}, A′_{2,B}, and A′_{3,B} from the blue pixel X22 are output according to the timing as shown in FIG. 11.

Referring to FIG. 11, when the first and third gate signals PG1_0 and PG2_180 having a phase difference of 180° therebetween are supplied to the blue pixel X22 at the first time point t0 as shown in FIG. 6B, the blue pixel X22 outputs the first and third blue pixel charges A′_{0,B} and A′_{2,B} that are simultaneously measured. When the second and fourth gate signals PG1_90 and PG2_270 having a phase difference of 180° therebetween are supplied to the blue pixel X22 at the second time point t1, the blue pixel X22 outputs the second and fourth blue pixel charges A′_{1,B} and A′_{3,B} that are simultaneously measured. The integral time Tᵢₙₜ exists between the first time point t0 and the second time point t1.

Since the blue pixel X22 cannot simultaneously measure the first to fourth blue pixel signals A′_{0,B}, A′_{1,B}, A′_{2,B}, and A′_{3,B}, the blue pixel X22 measures two pixel charges at a time two times with a time difference Tᵢₙₜ therebetween.

The first to fourth blue pixel charges A′_{0,B}, A′_{1,B}, A′_{2,B}, and A′_{3,B} are converted to first to fourth digital blue pixel signals A_{0,B}, A_{1,B}, A_{2,B}, and A_{3,B} by the CDS/ADC unit 18. The color and depth image generation unit 19 generates a color image by calculating blue color information C_{B} of the blue pixel X22 based on the first to fourth digital blue pixel signals A_{0,B}, A_{1,B}, A_{2,B}, and A_{3,B}.

The color and depth image generation unit 19 calculates the blue color information C_{B} by summing the first to fourth digital blue pixel signals A_{0,B}, A_{1,B}, A_{2,B}, and A_{3,B} of the blue pixel X22 by using Equation 16.

C_{N}=A_{0,B}+A_{1,B}+A_{2,B}+A_{3,B} (16)

The color and depth image generation unit 19 can estimate the phase difference \hat{θ}_{B} of the blue pixel X22 from the first to fourth digital blue pixel signals A_{3,B}, A_{1,B}, A_{2,B}, and A_{3,B} of the blue pixel X22 by using Equation 17.

$${\hat{θ}}_{B} = 2 π {f}_{m} {t}_{Δ , B} = {tan}^{- 1} \frac{{A}_{1 , B} - {A}_{3 , B}}{{A}_{0 , B} - {A}_{2 , B}} \qquad ( 17 )$$

Accordingly, the color and depth image generation unit 19 calculates depth information \hat{d}_{B} of the blue pixel X22 by using Equation 18.

$${\hat{d}}_{B} = \frac{c}{4 π {f}_{m}} {\hat{θ}}_{B} \qquad ( 18 )$$

A color image is displayed by combining three separated red, green, and blue color (RGB) values. Since each pixel Xᵢⱼ (i=1˜m, j=1˜n) determines only a single red, green, or blue color value, a technique of estimating or interpolating the other two colors from surrounding pixels in the color image is used to obtain the other two colors for each pixel. This type of estimating and interpolating technique is called “demosaicing”.

The term “demosaicing” originates from the fact that a color filter array (CFA) arranged in a mosaic pattern as shown in FIG. 7 is used in the front of the image sensor 10. The mosaic pattern has only one color value for each pixel. Thus, to obtain a full-color image, the mosaic pattern may be demosaiced. Accordingly, demosaicing is a technique of interpolating an image captured using a mosaic pattern CFA so that the whole RGB values are associated with all pixels.

There are a plurality of available demosaicing techniques. One of the simplest demosaicing methods is a bi-linear interpolation method. The bi-linear interpolation method uses three color planes independently interpolated using symmetric linear interpolation. The bi-linear interpolation method uses the nearest pixel of a pixel having the same color as a color being interpolated. A full-color image is restored by using RGB values obtained from red, green, and blue pixels and a demosaicing algorithm for combining the same.

FIG. 12 is a block diagram of an image sensing system 160 using the image sensor 10 of FIG. 3, according to an embodiment of the inventive concept.

Referring to FIG. 12, the image sensing system 160 includes a processor 161 combined with the image sensor 10 of FIG. 3. The image sensing system 160 includes individual integrated circuits, or both the processor 161 and the image sensor 10 may be included in a same integrated circuit. The processor 161 may be a microprocessor, an image processor, or another arbitrary type of control circuit (e.g., an application-specific integrated circuit (ASIC)). The processor 161 includes an image sensor control unit 162, an image signal processor (ISP) 163, and an interface unit 164. The image sensor control unit 162 outputs a control signal to the image sensor 10. The ISP 163 receives and signal-processes image data including a color image and a depth image output from the image sensor 10. The interface unit 164 transmits the signal-processed data to a display 165 to display the signal-processed data.

The image sensor 10 includes a plurality of pixels and obtains a color image and a depth image from the plurality of pixels. The image sensor 10 removes a pixel signal obtained by using background light from a pixel signal obtained by using modulated light and the background light. The image sensor 10 generates a color image and a depth image by calculating color information and depth information of a corresponding pixel based on the pixel signal from which the pixel signal obtained by using background light has been removed. The image sensor 10 generates a color image of a target object by combining a plurality of pieces of color information of the plurality of pixels. The image sensor 10 generates a depth image of the target object by combining a plurality of pieces of depth information of the plurality of pixels.

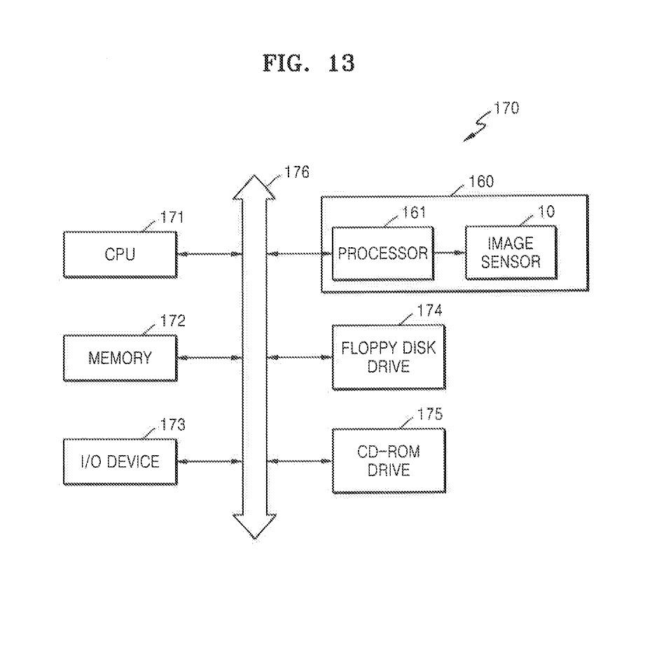

FIG. 13 is a block diagram of a computer system 170 including the image processing system 160 of FIG. 12, according to an embodiment of the inventive concept.

Referring to FIG. 13, the computer system 170 includes the image processing system 160. The computer system 170 further includes a central processing unit (CPU) 171, a memory 172, and an input/output (I/O) device 173. In addition, the computer system 170 may further include a floppy disk drive 174 and a compact disc read-only memory (CD-ROM) drive 175. In the computer system 170, the CPU 171, the memory 172, the I/O device 173, the floppy disk drive 174, the CD-ROM drive 175, and the image sensing system 160 are connected to each other via a system bus 176. Data provided by the I/O device 173 or the image sensing system 160 or processed by the CPU 171 is stored in the memory 172. The memory 172 includes random-access memory (RAM). In addition, the memory 172 may include a memory card including a nonvolatile memory device, such as a NAND flash memory, or a semiconductor disk device (e.g., a solid state disk (SSD)).

The image processing system 160 includes the image sensor 10 and the processor 161 for controlling the image sensor 10. The image sensor 10 includes a plurality of pixels and obtains a color image and a depth image from the plurality of pixels. The image sensor 10 removes a pixel signal obtained by using background light from a pixel signal obtained by using modulated light and the background light. The image sensor 10 generates a color image and a depth image by calculating color information and depth information of a corresponding pixel based on the pixel signal from which the pixel signal obtained by using background light has been removed. The image sensor 10 generates a color image of a target object by combining a plurality of pieces of color information of the plurality of pixels. The image sensor 10 generates a depth image of the target object by combining a plurality of pieces of depth information of the plurality of pixels.

While the inventive concept has been particularly shown and described with reference to exemplary embodiments thereof, it will be understood by one of ordinary skill in the art that various modifications and other equivalent embodiments may be made therefrom. Although it has been described in the inventive concept that each pixel has a two-tap pixel structure, the inventive concept is not limited thereto and may employ pixels having a one-tap pixel structure or a four-tap pixel structure. Therefore, the true scope will be defined by the following claims.

What is claimed is:

1. A depth-sensing pixel comprising:
a first photoelectric conversion device configured to generate a first electrical charge by converting amplitude-modulated modulated light reflected by a subject;
a first capture transistor, controlled by a capture signal applied to the control gate of the first capture transistor, and the first photoelectric conversion device being connected to the drain of the first capture transistor; and
a first transfer transistor, controlled by a transfer signal applied to the control gate of the first transfer transistor, the source of the first capture transistor being connected to the drain of the first transfer transistor; and
a first floating diffusion region connected to the source of the first transfer transistor.

2. The depth-sensing pixel of claim 1, wherein the capture signal is maintained High while the first capture transistor is accumulating the first electrical charge.

3. The depth-sensing pixel of claim 1, wherein the first transfer signal is maintained Low while the first capture transistor is accumulating the first electrical charge.

4. The depth-sensing pixel of claim 1, wherein after the first capture transistor accumulates the first electrical charge for a first predetermined period of time, the capture signal is changed to Low, and the transfer signal is changed to High to thereby transfer the accumulated first electrical charge to the first floating diffusion region.

5. The depth-sensing pixel of claim 4, wherein after the accumulated first electrical charge is transferred to the first floating diffusion region, signal-level sampling is performed in the first floating diffusion region.

6. The depth-sensing pixel of claim 4, further comprising a first reset transistor, controlled by a reset signal applied to the control gate of the first reset transistor, a power source voltage being applied to the drain of the first reset transistor, and the first floating diffusion region being connected to the source of the first reset transistor,
wherein reset-level sampling is performed at the first floating diffusion region by controlling the reset signal before the capture signal is changed to Low and the transfer signal is changed to high.

7. The depth-sensing pixel of claim 1, wherein impurity densities of the source and drain regions of the first capture transistor are lower than an impurity density of the first floating diffusion region.

8. The depth-sensing pixel of claim 1, wherein the modulated light is periodic, and wherein the capture signal has a phase difference of at least one of 0°, 90°, 180°, and 270° with respect to the modulated light.

9. The depth-sensing pixel of claim 1, wherein the modulated light is periodic, and further comprising a second capture transistor, wherein capture signals having phase differences of 0° and 180° with respect to the modulated light are applied to the first capture transistor, and capture signals having phase differences of 90° and 270° with respect to the modulated light are applied to the second capture transistor.

10. The depth-sensing pixel of claim 1, further comprising:
a second capture transistor;
a third capture transistor; and
a fourth capture transistor;
wherein the modulated light is periodic, and
wherein a capture signal having a phase difference of 0° with respect to the modulated light is applied to the first capture transistor, a capture signal having a phase difference of 90° with respect to the modulated light is applied to the second capture transistor, a capture signal having a phase difference of 180° with respect to the modulated light is applied to the third capture transistors, and a capture signal having a phase difference of 270° with respect to the modulated light is applied to the fourth capture transistor.

11. The depth-sensing pixel of claim 1, wherein the depth-sensing pixel converts an light passing through a color filter and converts a predetermined one of a red-filtered light, a green-filtered light, and a blue-filtered light to an electrical charge.

12. A three-dimensional (3D) image sensor comprising:
a light source configured to emit amplitude-modulated light to a subject;
a pixel array including a plurality of sensing pixels for outputting color-filtered pixel signals according to the modulated light reflected by the subject;
a row decoder configured to generate a driving signal for driving each row of the pixel array;
an image processing unit configured to generate a color image from the color-filtered pixel signals output from the pixel array and to generate a depth image from color-filtered pixel signals output from the pixel array; and
a timing circuit configured to provide a timing signal and a control signal to the row decoder and the image processing unit,
wherein each of the sensing pixels comprises:
a first photoelectric conversion device configured to generate a first electrical charge by converting the modulated light reflected by the subject;
a first capture transistor, controlled by a capture signal applied to the control gate of the first capture transistor, and the first photoelectric conversion device being connected to the drain of the first capture transistor;
a first transfer transistor, controlled by a transfer signal applied to the control gate of the first transfer transistor, the source of the first capture transistor being connected to the drain of the first transfer transistor; and
a first floating diffusion region being connected to the source of the first transfer transistor.

13. The image sensor of claim 12, further comprising:
a timing circuit configured to provide a timing signal and a control signal to the row decoder and the image processing unit,
wherein each of the sensing pixels comprises:
a first photoelectric conversion device configured to generate a first electrical charge by converting the modulated light reflected by the subject;
a first capture transistor, controlled by a capture signal applied to the control gate of the first capture transistor, and the first photoelectric conversion device being connected to the drain of the first capture transistor; and
a first transfer transistor, controlled by a transfer signal applied to the control gate of the first transfer transistor, the source of the first capture transistor being connected to the drain of the first transfer transistor; and
a first floating diffusion region being connected to the source of the first transfer transistor.

14. The image sensor of claim 12, wherein the capture signal is maintained High while the first capture transistor is accumulating the first electrical charge.

15. The image sensor of claim 12, wherein the transfer signal is maintained Low while the first capture transistor is accumulating the first electrical charge.

16. The image sensor of claim 12, wherein after the first capture transistor accumulates the first electrical charge for a predetermined period of time, the capture signal is changed to Low, and the transfer signal is changed to High to thereby transfer the accumulated first electrical charge to the first floating diffusion region.

17. A depth-sensing pixel comprising:
first, second, third and fourth co-adjacent photoelectric conversion devices configured to generate a first, second, third and fourth electrical charge, respectively, by converting amplitude-modulated modulated light reflected by a subject;
first, second, third and fourth transfer transistors, controlled by a transfer signal applied to the control gates of the first, second, third and fourth transfer transistors, for transferring the first, second, third and fourth electrical charges; and
first, second, third and fourth floating diffusion regions connected to the source of the first, second, third and fourth transfer transistors, respectively, for storing the first electrical charge accumulated, the second electrical charge accumulated, the third electrical charge accumulated and the fourth electrical charge accumulated, respectively.

18. The depth-sensing pixel of claim 17, further comprising
a first capture transistor, controlled by a capture signal applied to the control gate of the first capture transistor, and the first photoelectric conversion device being connected to the drain of the first capture transistor; the source of the first capture transistor being connected to the drain of the first transfer transistor;
a second capture transistor, controlled by a capture signal applied to the control gate of the second capture transistor, and the second photoelectric conversion device being connected to the drain of the second capture transistor; the source of the second capture transistor being connected to the drain of the second transfer transistor;
a third capture transistor, controlled by a capture signal applied to the control gate of the third capture transistor, and the third photoelectric conversion device being connected to the drain of the third capture transistor; the source of the third capture transistor being connected to the drain of the third transfer transistor; and
a fourth capture transistor, controlled by a capture signal applied to the control gate of the fourth capture transistor, and the fourth photoelectric conversion device being connected to the drain of the fourth capture transistor; the source of the fourth capture transistor being connected to the drain of the fourth transfer transistor.

19. The depth-sensing pixel of claim 18, wherein the modulated light is periodic, and wherein a capture signal having a phase difference of 0° with respect to the modulated light is applied to the first capture transistor, a capture signal having a phase difference of 90° with respect to the modulated light is applied to the second capture transistor, a capture signal having a phase difference of 180° with respect to the modulated light is applied to the third capture transistors, and a capture signal having a phase difference of 270° with respect to the modulated light is applied to the fourth capture transistor.

20. The depth-sensing pixel of claim 19, further comprising a color filter, wherein the modulated light passes through the color filter and the depth-sensing pixel converts a predetermined one of red-filtered modulated light, green-filtered modulated light, and blue-filtered modulated light into the first, second, third and fourth electrical charges.
